(19) United States
(12) Patent Application Publication
(10) Pub. No.: US 2007/0030830 A1
(43) Pub. Date: Feb. 8, 2007

(54) Method and apparatus for performing inter-frequency and inter-rat handover measurements in mbms

(76) Inventors: Jacques Sagne, Montesquieu (FR); Peter Edlund, Tumba (SE); Joakim Bergstrom, Stockholm (SE); Dirk Gerstenberger, Kista (SE)

Correspondence Address: ERICSSON INC., 6300 LEGACY DRIVE, M/S EVR C11, PLANO, TX, 75024, US

(21) Appl. No.: 10/595,643

(22) PCT Filed: Nov. 12, 2004
(86) PCT No.: PCT/SE04/01656

§ 371 Date: May 2, 2006

(30) Foreign Application Priority Data
Nov. 12, 2003 (SE) 0303031-9

(51) Int. Cl. H04J 3/00

(52) U.S. Cl. 370/336

(57) ABSTRACT

Disclosed are systems and methods that allow the a mobile communications device to perform inter-frequency and inter-RAT measurements while receiving MBMS data. As disclosed, control of measurement occasions are decided on by the UE using Discontinuous Reception during Forward Access Channel reception. Using aspects of the disclosed embodiments, each UE individually decides when to perform inter-frequency/RAT measurements (provided performance requirements on cell reselection are met). Outer coding procedures may then be performed to recover data lost during the measurements.

### FIELD OF THE INVENTION

The present invention relates to performing measurements for inter-frequency and inter-radio access technology (inter-RAT) handover while receiving Multimedia Broadcast/Multicast Service (MBMS) data in a point-to-multipoint transmission environment.

### SUMMARY OF THE INVENTION

The objective of MBMS is the efficient use of the radio resources by allowing the simultaneous distribution of identical multimedia data to multiple receivers using the same radio channel(s). MBMS defines a number of new procedures to support point-to-multipoint (p-t-m) transmission to multiple users. In addition, MBMS uses existing procedures for point-to-point (p-t-p) transmission to a single user.

It is expected that MBMS will allow operators to offer new services by allowing the efficient broadcast or multicast of popular multimedia services such as news, traffic information and sports clips. The 3rd Generation Partnership Project (3GPP) is currently standardizing the Multimedia Broadcast/Multicast Service (MBMS) as part of the new features to be included in Release 6 of its specifications.

According to the proposed standards, all user equipment (UE) or mobile units receiving MBMS share a common downlink. Thus, there is no possibility for the network to consider individually signalled measurement occasions for each user equipment. The proposed standard assumes that the number of MBMS users in a cell will be large, and thus, it will difficult if not impossible to coordinate the signalled measurement occasions between all user equipments without a loss of MBMS transmission capacity.

However, if the user equipment is focused on receiving point-to-multipoint MBMS data on a Forward Access Channel (FACH), the user equipment may not be able to perform measurements relating to inter-frequency and/or inter-RAT (Radio Access Technology). Therefore, there is a need for a system and/or method that can ensure a certain level of Quality of Service (QoS), e.g. that page messages or large amounts of MBMS-data are not lost, while performing inter-frequency/RAT measurements concurrently with point-to-multipoint MBMS data reception.

### SUMMARY OF THE INVENTION

Disclosed are systems and methods that allow the user equipment to perform inter-frequency and inter-RAT measurements while receiving MBMS data. As disclosed, control of measurement occasions is decided on by the user equipment using Discontinuous Reception (“DRX”) during Forward Access Channel (“FACH”) reception. Using aspects of the disclosed embodiments, each user equipment individually decides when to perform inter-frequency/RAT measurements (provided performance requirements on cell reselection are met). Outer coding procedures may then be performed to recover data lost during the measurements.

These and other features, and advantages, will be more clearly understood from the following detailed description taken in conjunction with the accompanying drawings. It is important to note the drawings are not intended to represent the only aspect of the invention.

### BRIEF DESCRIPTION OF THE DRAWINGS

FIG. 1 illustrates a network architecture incorporating various aspects of the present invention.

FIG. 2 illustrates a method performed by a transmitter in a network node incorporating various aspects of the present invention.

FIG. 3 illustrates measurement occasions for MBMS.

FIG. 4 is a functional diagram of user equipment incorporating dual receivers which implement various aspects of the present invention.

FIG. 5 is a functional diagram for user equipment incorporating a single receiver which incorporates various aspects of the present invention.

FIGS. 6a and 6b are methods incorporating various aspects of the present invention.

FIG. 7 illustrates measurement occasions during paging reception, reception of MBMS, and measurements.

### DETAILED DESCRIPTION

For the purposes of the present disclosure, various acronyms are used, and the definitions of which are listed below:
CRNC Controlling Radio Network Controller
DCH compressed mode Dedicated Channel compressed mode. Compressed mode is used in CELL_DCH for doing inter-frequency and inter-RAT measurements.
DRX Discontinuous transmission. Currently the UE may use Discontinuous Reception (DRX) in idle mode and CELL_PCH and URA_PCH in order to reduce power consumption. The term DRX as used in the context of this application is the general term discontinuous transmission.
DTX Discontinuous Transmission
FACH Forward Access Channel
inter-RAT Inter-Radio Access Technology. In this case, non-WCDMA technology, e.g. GSM or TD-CDMA or TD-SCDMA.
MBMS Multimedia Broadcast and Multicast System
MTCH MBMS Traffic channel.
Node B A logical node responsible for radio transmission/reception in one or more cells to/from the User Equipment. Terminates the lub-interface towards the RNC.
Outer Coding Outer coding with respect to an inner coding
PCH Paging Channel
PICH Page Indicator Channel
ptm Point-to-multipoint
ptp Point-to-point
QoS Quality of Service
RAT Radio Access Technology
RNC Radio Network Controller
S-CCPCH Secondary Common Control Channel
SF 128 code Spreading Factor
SFN System Frame Number
TTI Transmission Time Interval
Tx Transmit
UE User Equipment
UTRAN Universal Terrestrial Radio Access Network

For the purposes of promoting an understanding of the principles of the present inventions, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the inventions as described herein are contemplated as would normally occur to one skilled in the art to which the invention relates.

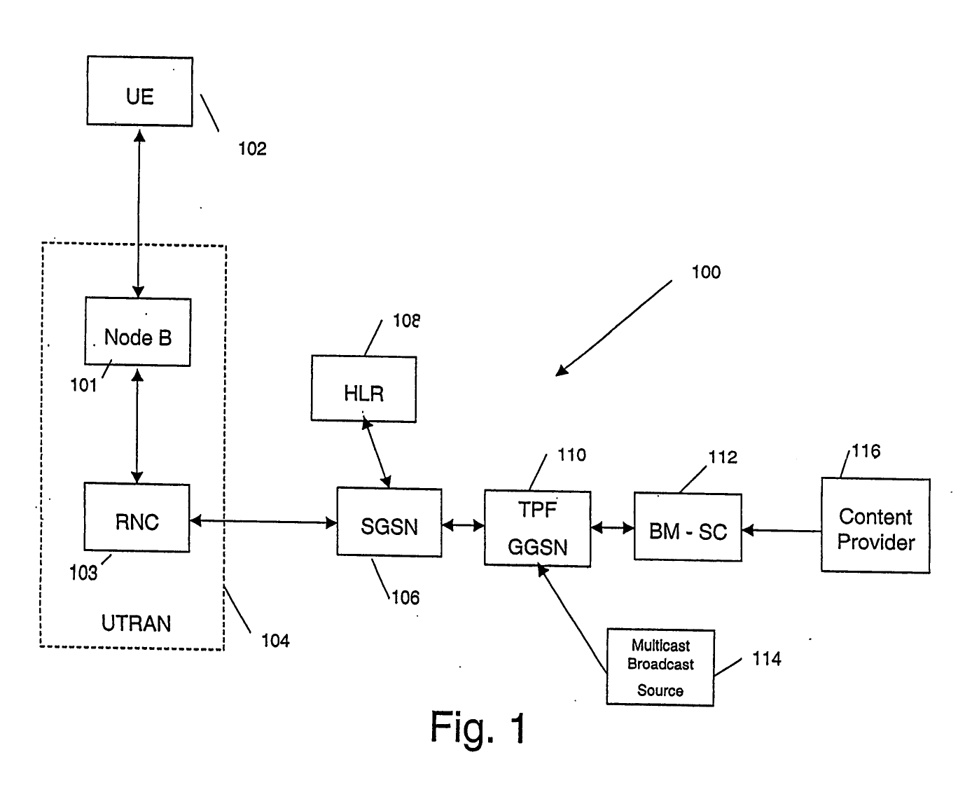

Turning now to FIG. 1, there is presented an exemplary network 100 incorporating various aspects of the present embodiment. For sake of example, the network 100 utilizes techniques, standards, and systems based on a Universal Mobile Telephone System (“UMTS”). It should be apparent to one of ordinary skill in the art that the various embodiments of the present invention may be employed in other networks and systems.

A UMTS network typically consists of three interacting domains: Core Network (CN), UMTS Terrestrial Radio Access Network (UTRAN) and User Equipment (UE). The main function of the core network is to provide switching, routing and transit for user traffic. The core network also contains the databases and network management functions. A UTRAN 104 provides the air interface access method for User Equipment. Typically, the base stations are referred as Node-B, such as Node-B 101 and control equipment for Node-B's is called Radio Network Controller (RNC), one RNC 103 is illustrated. The network 100 also includes several mobile units or user equipment, of which only user equipment 102 is illustrated. The user equipment 102 communicates with the UTRAN 104 in a conventional manner.

To achieve a MBMS environment, a number of new capabilities are added to existing 3GPP network entities and a number of new functional entities are added. Thus, the “existing” packet-switched domain functional entities (e.g., GGSN, SGSN, UTRAN, and UE) may be enhanced to provide the MBMS Bearer Service.

As illustrated in FIG. 1, the UTRAN 104 may communicate with a Serving GPRS Support Node (SGSN) 106 acting as the gateway between the UTRAN 104 and the core network. The SGSN 106 communicates with a Home Location Register (HLR) 108, which typically contains a database for storing subscriber data. Thus, the SGSN 106 can access said Home Location Register 108 to determine whether to allow the user equipment 102 to access the core network. The SGSN 106's role within MBMS architecture is to perform user individual MBMS bearer service control functions and to provide MBMS transmissions to the UTRAN 104. The SGSN 106 may provide support for intra-SGSN and inter-SGSN mobility procedures. Specifically, the SGSN 106 stores a user-specific MBMS UE context for each activated multicast MBMS bearer service and passes these contexts to the SGSN during inter-SGSN mobility procedures.

The SGSN 106 also communicates with a Gateway GPRS Support Node (GGSN) 110, which typically functions as a gateway between the core network or cellular network and an IP network. The role of the GGSN 110 within the MBMS environment is to serve as an entry point for IP multicast traffic, such as MBMS data. The GGSN 110 is able to request the establishment of a bearer plane for a broadcast or multicast MBMS transmission. Further, the GGSN 110 is able to tear down the established bearer plane. Bearer plane establishment for multicast services is carried out towards those SGSNs that have requested to receive transmissions for the specific multicast MBMS bearer service. The GGSN 110 is also able to receive IP multicast traffic (whether from a BM-SC 112 or other data sources, such as multi-cast broadcast source 114) and to route this data to the proper GTP tunnels as part of the MBMS bearer service.

The BM-SC 112 provides functions for MBMS user service provisioning and delivery. The BM-SC 112 may also serve as an entry point for content provider MBMS transmissions, for instance, from a content provider 116. Additionally, the BM-SC 112 may also be used to authorize and initiate MBMS bearer services within the network and can be used to schedule and deliver MBMS transmissions. The BM-SC 112 is a functional entity, which must exist for each MBMS user service.

MBMS data may be distributed to multiple users through a MBMS distribution tree that can go through many BSCs/RNCs, many SGSNs and one or more GGSNs. Furthermore some bearer resources may be shared between many users accessing the same MBMS bearer service in order to save resources. As a result, each branch of a MBMS distribution tree will typically have the same QoS for all of its branches.

Thus, when a branch of the MBMS distribution tree has been created, it is not possible for another branch (e.g. due to arrival of a new user equipment or change of location of a user equipment with removal of a branch and addition of a new one) to impact the QoS of already established branches. In other words, there is no QoS value negotiation between UMTS network elements. This implies that some branches may not be established if QoS requirement cannot be accepted by the concerned network node. Also in the UTRAN 104, there is typically no QoS (re-)negotiation feature for the MBMS bearer service. Except for various aspects disclosed herein, there is currently no special solution that allows the user equipment 102 to perform inter-frequency and inter-RAT measurements while receiving MBMS data. Currently, the user equipment 102 would either not perform measurements during MBMS reception, which impacts mobility and results in loss of MBMS data and excessive repetitions or point to point—repair.

In general, measurements occasions may be scheduled in two different ways: either autonomously by each user equipment 102, or by the UTRAN 104. This disclosure will now focus on methods and systems to enable measurement occasions scheduled by said user equipment 102.

When the user equipment 102 tunes to another frequency to conduct a measurement, i.e. to perform inter-frequency and inter-RAT measurements, while receiving MBMS data, some MBMS data loss will occur. Thus, it is desirable to have a mechanism for recovering the lost packets. One mechanism which may be used is the implementation of an outer coding to recover the partial losses. In general, any error correcting code can be used as an outer code, e.g. Convolution code, Turbo code, CRC code, Reed-Solomon code. An inner code may, e.g. be a spreading code as a specific case of a repetition code.

If discontinuous reception (DRX) on a forward access channel (FACH) is used, outer coding on radio layer can be used to compensate for the data loss during DRX occasions. Outer coding will encode a number of inner code blocks (in case of radio layer outer coding, a number of transport blocks add some parity information that is used to recover inner code block errors.)

In this example, it is the user equipment 102 that is performing the measurement actively, and the UTRAN 104 is just transmitting the MBMS service, therefore, a network node, such as Node-B 101 is relatively passive. In some embodiments, the network node is just providing the corresponding outer code during the transmitting process.

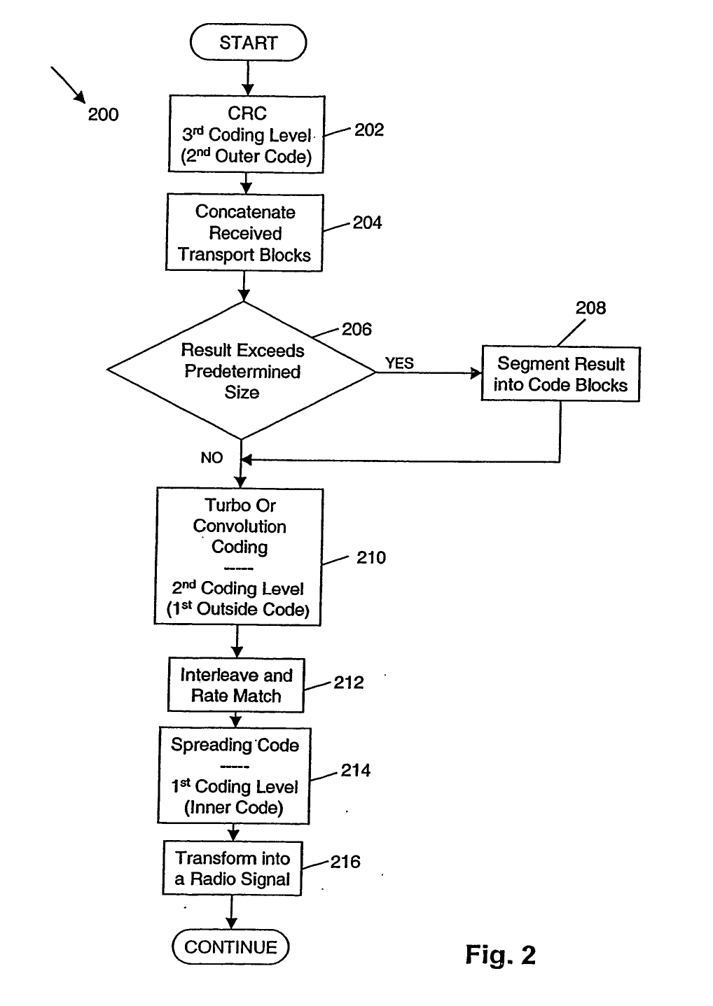

Turning now to FIG. 2, there is a method 200 performed by a transmitter in a network node, e.g. node-B 101, which incorporates various aspects of the present invention. Typically, data sent from the network node is in form of transport block sets once every transmission time interval (TTI). The transmission time interval is transport-channel specific. In this illustrative example the TTI will be defined as 10 ms. In step 202, the network node, e.g. the node B, attaches a Cycle Redundancy Check (CRC) to each transport block received during the TTI to encode the 2^{nd} outer code. In step 204, the network node concatenates the received transport blocks. Typically, all transport blocks in a TTI are serially concatenated. In step 206, a determination is made as to whether the result of the concatenation exceeds a predetermined size, if yes, then in step 208, the result is segmented into code blocks. In other words, if the number of bits in a TTI is larger than the maximum size of a code block in question, then code block segmentation is performed after the concatenation of the transport blocks. The maximum size of the code blocks depends on various factors, including whether convolutional coding or turbo coding is performed. In step 210, the code blocks are then processed through a convolutional or turbo encoder which encodes the 1^{st} outer code. In step 212, the code blocks may be interleaved and rate matched and further processed together with possible other transport channels.

In step 214 they are spread by a spreading code which encodes the inner code before they are transformed into a radio signal (step 216) which is sent over an antenna.

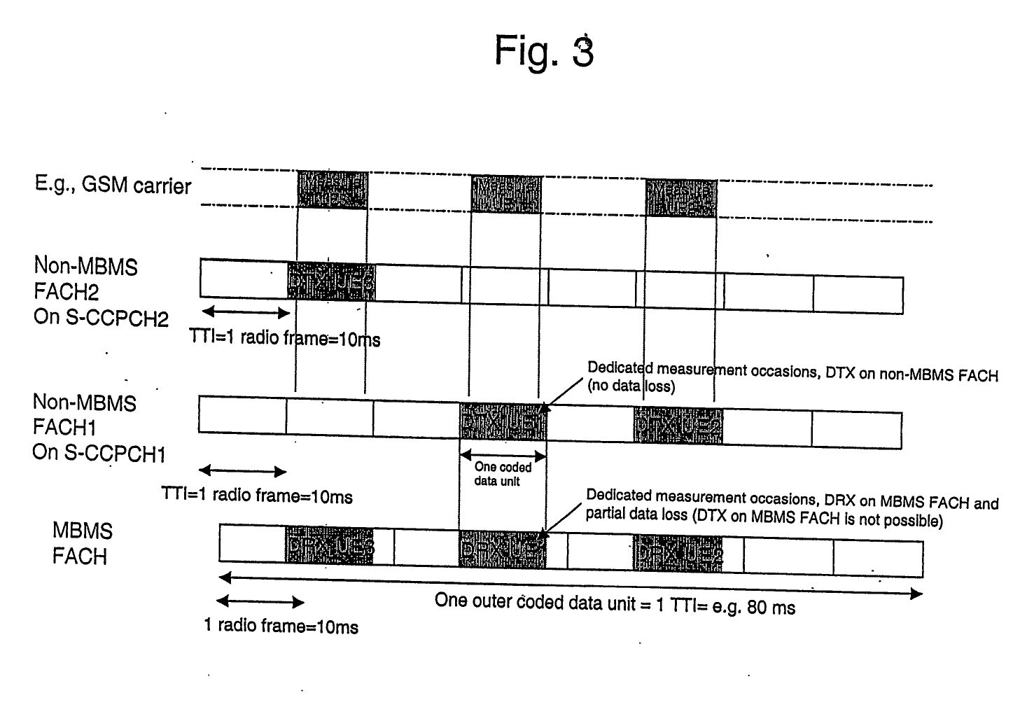

FIG. 3 illustrates an example of a measurement occasion for MBMS in a CELL_FACH state. A CELL_FACH state is one of several RRC service states. A CELL_FACH state is typically characterized by data transmitted through RACH and FACH. There is no dedicated channel allocated and the UE listens to the BCH.

FIG. 3 describes what a plurality of different user equipments (UE1, UE2 and UE3) does while performing measurements and also at the same time listen to their own FACH channel 304. In this illustrative example, the user equipments UE1 and UE2 listen to the same FACH (1) on S-CCPCH (1) and the UE3 listens to a different FACH (2) at another S-CCPCH (2). In this example, all the user equipments measure the GSM carrier 302. However, since for the FACH channel (a non MBMS channel) needs to be maintained, e.g. for other services than MBMS, while listening to MBMS in case the user equipment is in a CELL_FACH state the user equipment will perform measurements at UE specific occasions. These occasions are calculated according to the current specifications according to the user equipment identity C-RNTI. Since the network knows when the user equipment does these measurements it can apply DTX. In the downlink for FACH, the DTX gap created to one user equipment may be used for another user equipment to fill up the radio frame with bits.

During the time there is DTX (the time is in whole TTIs, and in this example the TTI on the FACHs are 10 ms which is the same as the radio frame length) the user equipment can do inter-RAT and inter-frequency measurements. However, in case there is also MBMS in parallel which is the case for UE1-UE3, the user equipments should autonomously also leave the MBMS channel (do DRX of that channel) because a non dual receiver user equipment can not do both the MBMS reception and the measurement at the same time on different frequencies (like when doing measurements on, e.g., GSM which is the example in FIG. 3. Also one can note that the different non-MBMS FACHes can have different transmit timing compared to the MBMS FACH and to each other (although the transmit timing for non MBMS FACH1 on S-CCPCH1 have the same timing as non MBMS FACH2 on S-CCPCH2 in this example figure), and that the different user equipments will leave the MBMS FACH at a different time (since they have different DTX schedules on the non MBMS FACH).

When the user equipment does the measurements, it will miss one or several parts of a inner coded block equal to one radio frame of the MBMS FACH. However, because there is outer coding performed on TTI basis this can be recovered. In this example, the 2^{nd} and 3^{rd} coding level (Turbo or Convolutional coding and CRC coding respectively) is used on a TTI of 80 ms basis.

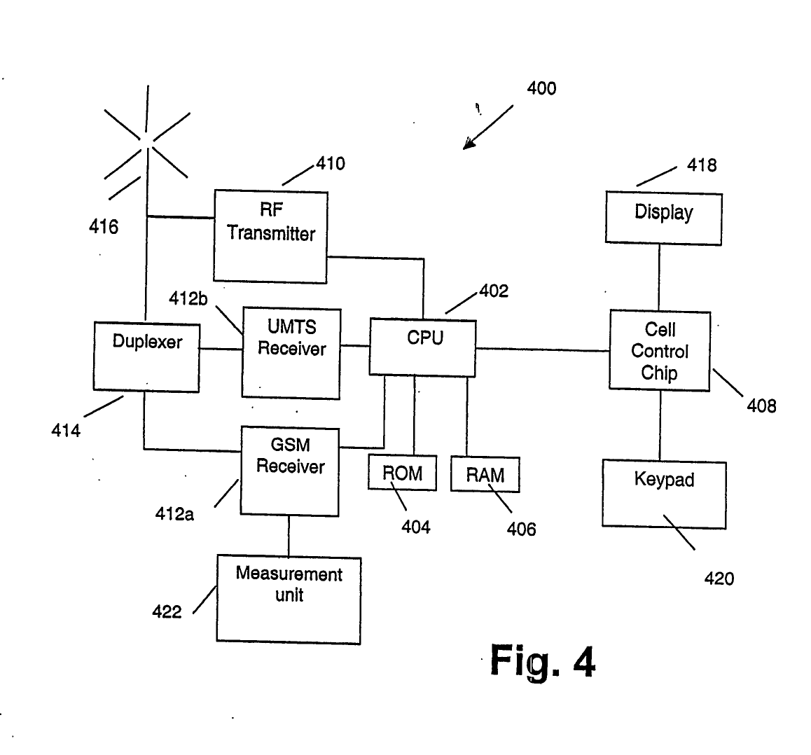

User equipments with dual receivers may also be able to perform the measurements without data loss and will therefore experience a better QoS, e.g. better streaming performance, less ptp-repair. FIG. 4 illustrates a schematic diagram of an exemplary user equipment 400 for implementing various aspects of the present invention. The heart of the mobile terminal 400 is a central processing unit (“CPU”) 402. The CPU 402 receives instructions from a memory device, such as a read-only memory (“ROM”) 404. There may also be additional memory devices, such as a random access memory (“RAM”) 406. The RAM 406 is used for storing temporary data, such as received MBMS data, user-definable numbers or network variable values and flags. The CPU 402 is also in communication with a cellular control chip 408, which retains the cellular identification number and controls operational frequencies for an RF transmitter 410, a GSM receiver 412a and a UMTS receiver 412b. The RF transmitter 410 and the receivers 412a and 412b are coupled by a duplexer 414 to an antenna 416. A measurement unit 422, which is coupled to the GSM receiver 412a, is responsible for interference measurements of neighbour cells applying other carrier frequencies. The CPU 402 may display output information on a display 418. There is also illustrated a keypad 420, e.g. equipped with a dual tone multi-frequency (“DTMF”) generator to allow calls to be made.

Thus, a user may enter commands by pressing the keypad 420. Upon a series of keyboard commands, the user equipment 400 may establish a MBMS session. In this example, the UMTS receiver 512b receives the MBMS data while the GSM receiver 412a is tuned to a different frequency and performs measurement events. In this configuration, there is no loss of data.

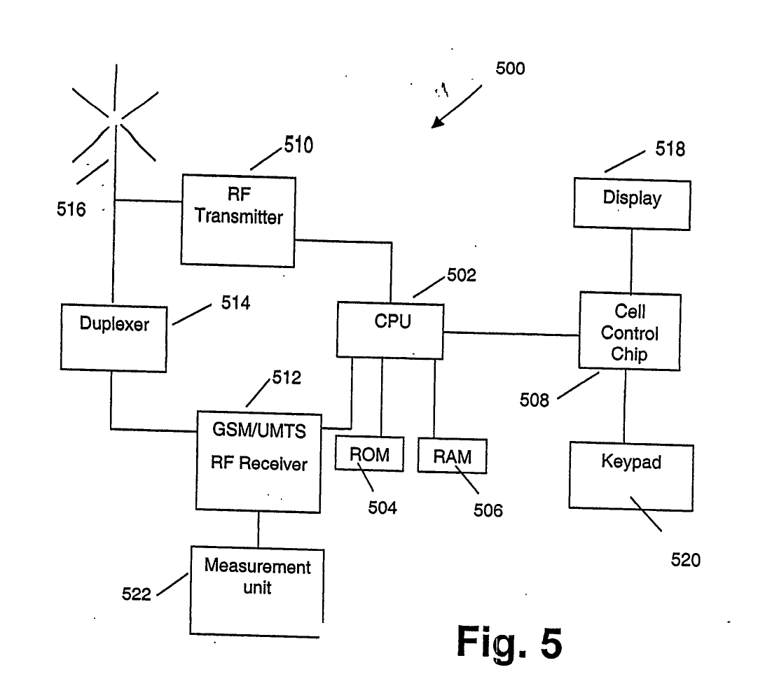

However, dual receivers may be costly in terms of complexity and power consumption for such user equipments. FIG. 5 illustrates a schematic diagram of an exemplary user equipment 500 for implementing various aspects of the present invention using a single receiver. The heart of the mobile terminal 500 is a central processing unit (“CPU”) 502. The CPU 502 receives instructions from a memory device, such as a read-only memory (“ROMN”) 504. There may also be additional memory devices, such as a random access memory (“RAM”) 506. The RAM 506 is used for storing temporary data, such as received MBMS data, user-definable numbers or network variable values and flags. The CPU 502 is also in communication with a cellular control chip 508, which retains the cellular identification number and controls operational frequencies for an RF transmitter 510 and an RF receiver 512. The RF transmitter 510 and the RF receiver 512 are coupled by a duplexer 514 to an antenna 516. A measurement unit 522, which is coupled to the RF receiver 512, is responsible for interference measurements of neighbour cells. The CPU 502 may display output information on a display 518. There is also illustrated a keypad 520, e.g. equipped with a dual tone multi-frequency (“DTMF”) generator to allow calls to be made.

Thus, a user may enter controls by pressing the keypad 520. Upon a series of keyboard commands, the UE may establish a MBMS session. In this example, the RF receiver 512 receives the MBMS data, but temporarily switches to another frequency or RAT to perform measurements. Thus, the RF receiver 512 may be a dual UMTS/GSM receiver. During the time that the receiver has switched to perform measurements, e.g. during DRX, data on MBMS are lost, but which can be recovered by the use of outer coding as previously explained.

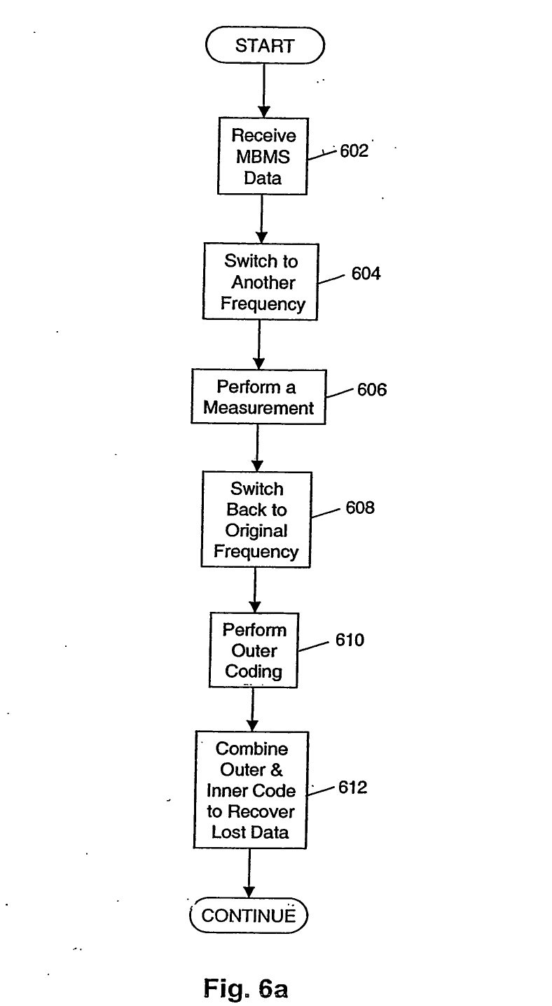

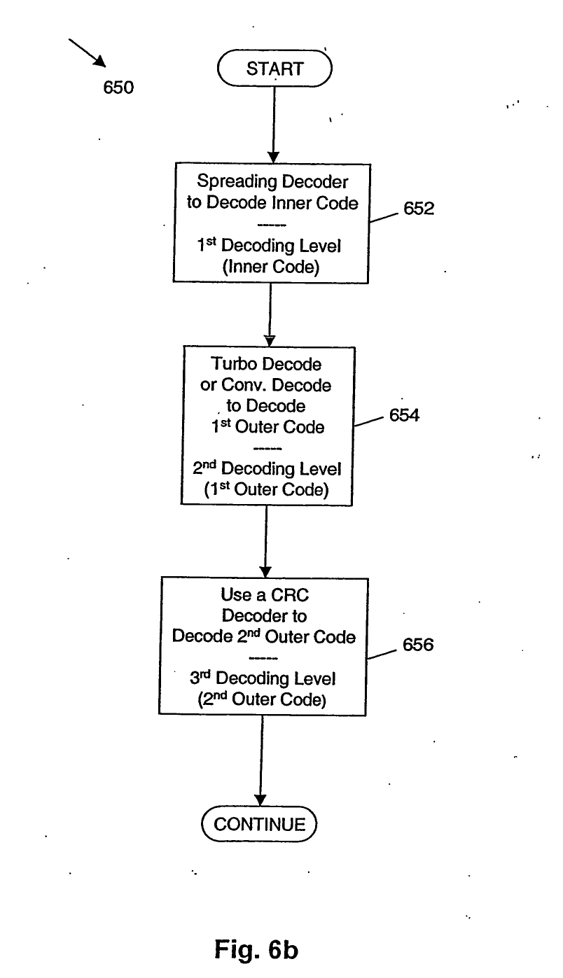

Turning now to FIG. 6a, there is a method 600 which may be implemented in the user equipment 500 having a single receiver as discussed above. In step 602, the user equipment is receiving MBMS data. In step 604, the user equipment switches to another frequency to perform a measurement (step 606). In step 608, the user equipment switches back to the original frequency to continue to receive the MBMS data. In step 610, the user equipment performs outer decoding to recover the lost MBMS data. In step 612, the user equipment combines the outer coding and inner coding to recover the MBMS frame.

Turning now to FIG. 6b, there is a method 650 performed by a user equipment which provides more detail regarding the outer decoding performed in the method 600. In step 652, the user equipment uses a spreading decoder or despreader to decode the inner code. In step 654, a turbo decoder or convolutional decoder is used to decode the first outer code. In step 656, a CRC decoder is used to decode the second outer code. The outer and inner codes than then be combined to recover the MBMS data.

Since it is a MBMS point to multipoint scenario, all user equipments will see the same download delay since they all listen to the same channel. However, there could be different amount of point-to-point repair from different user equipments if they on average have received more correct blocks of the MBMS transmission. Less point-to-point repair also means less resources/interference spent on this additional traffic. It should also be noted that the use of an outer code, either on radio or application layer, will improve the performance for the end-user, since e.g., exceptionally bad radio conditions may occasionally lead to lost transport blocks.

Various disclosed aspects of this invention is relatively simple to implement, does not require extra signalling, and does not have impacts on the S-CCPCH (Secondary Common Control Channel) according to previous standardization releases within. 3GPP. Furthermore, there is no need of paging rescheduling for idle or PCH user equipments, as measurements could be performed between paging occasions. Advantageously, user equipments in FACH could perform such measurements during “FACH measurement occasions” that a user equipment anyway have available for non-MBMS measurements in CELL_FACH state, whereas user equipments in DCH could utilize compressed mode gaps. This way, MBMS data loss will be minimized.

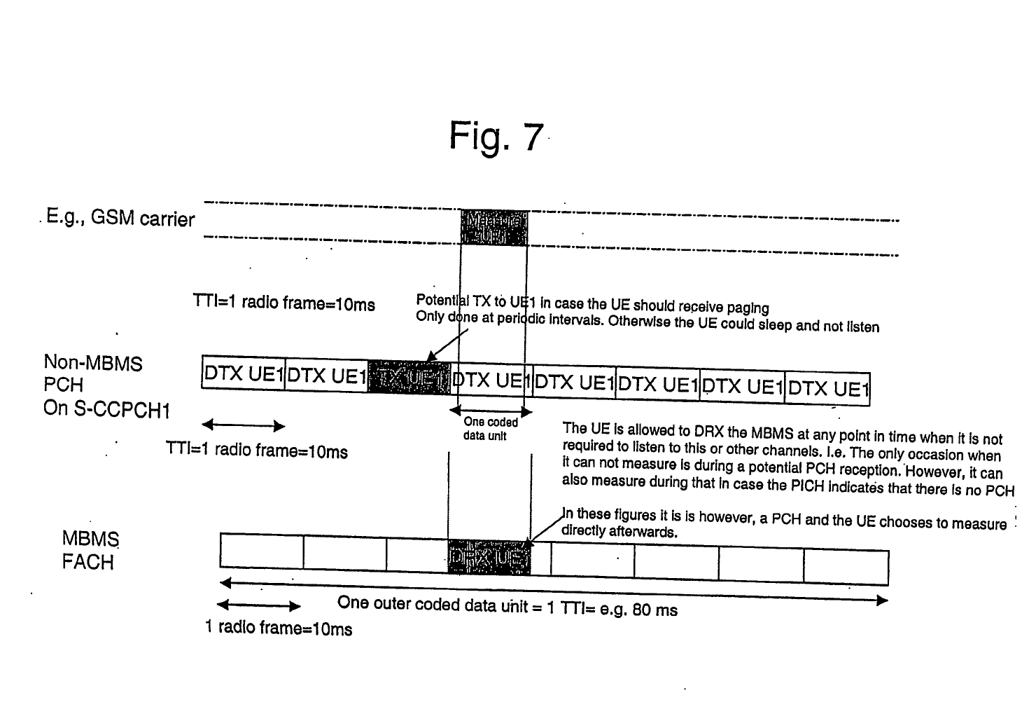

The above description focuses on CELL_FACH state. However, as one skilled in the art would recognize, the methods disclosed above would also work in other RRC service states, such as CELL_PCH, URA_PCH and idle mode. FIG. 7 describes a situation where the user equipment does the measurement anytime during non-reception of paging which may be applicable in these other RRC service states.

1-12. (canceled)

13. A method in a communication device for receiving Multimedia Broadcast and Multicast System (MBMS) data, comprising the steps of:
receiving MBMS data on a first frequency;
switching to a second frequency to perform a measurement;
performing a measurement;
switching back to the first frequency to continue to receive MBMS data; and,
performing outer decoding to recover MBMS data not received during the performing the measurement step.

14. The method recited in claim 13, wherein the step of performing outer decoding comprises the steps of:
despreading the MBMS data to decode inner code data;
using a first decoder to decode first outer code data;
using a redundancy checker decoder to decode second outer code; and,
combining the outer and inner code data to recover the MBMS data not received during the step of performing a measurement.

15. The method recited in claim 14, wherein the first decoder is a turbo decoder or convolution decoder.

16. A communication device, comprising:
a processor;
a memory coupled to the processor, wherein the memory includes instructions for:
receiving MBMS data on a first frequency;
switching to a second frequency to perform a measurement;
performing a measurement;
switching back to the first frequency to continue to receive MBMS data; and,
performing outer decoding to recover MBMS data not received during the performing the measurement step.

17. The communication device recited in claim 16, wherein the performing outer decoding instructions further comprises the steps of:
despreading the MBMS data to decode inner code data;
using a first decoder to decode first outer code data;
using a redundancy checker decoder to decode second outer code; and,
combining the outer and inner code data to recover the MBMS data not received during the performing the measurement step.

18. The communication device recited in claim 17, wherein the first decoder is a turbo decoder or convolution decoder.

19. A method in a transmitter of a network node, said method comprising the steps of:
receiving a series of transport blocks during a predetermined time period;
attaching a redundancy check to each transport block received during the predetermined time period to encode a second outer code data;
processing the code blocks through a first encoder to encode a first outer code data;
using a spreading code to encode inner code data; and,
transforming the inner code and outer code data into a radio signal such that the radio signal comprises transport blocks comprising inner code data and outer code data.

20. The method recited in claim 19, wherein the first coder is a convolution or turbo coder.

21. The method recited in claim 19, further comprising the step of serially concatenating all transport blocks in the predetermined time.
